(19) United States
(12) Patent Application Publication
(10) Pub. No.: US 2007/0185246 A1
(43) Pub. Date: Aug. 9, 2007

(54) Asphalt-epoxy resin compositions

(76) Inventors: Atsushi Fujitani, Tokyo (JP); Hayato Hirayama, Tokyo (JP); Takayuki Kobayashi, Tokyo (JP); Akira Seo, Tokyo (JP)

Correspondence Address: SHELL OIL COMPANY, P O BOX 2463, HOUSTON, TX, 772522463, US

(21) Appl. No.: 10/561,619

(22) PCT Filed: Jun. 24, 2004
(86) PCT No.: PCT/EP04/51220

§ 371 Date: Oct. 18, 2006

(30) Foreign Application Priority Data
Jun. 25, 2003 (JP) 2003-181786
Feb. 23, 2004 (JP) 2004-046934

(51) Int. Cl. C08L 95/00

(52) U.S. Cl. 524/59

(57) ABSTRACT

An asphalt-epoxy resin composition which contains in the indicated proportions (A) from 75 to 93 wt % asphalt, (B) from 1 to 5 wt % epoxy resin and (C) from 6 to 20 wt % maleic acid modified thermoplastic polymer wherein the total amount of (A)+(B)+(C) is 100 wt %, and wherein the aforementioned epoxy resin (B) is a ternary copolymer having (i) lower α-olefin, (ii) lower alkyl acrylate or methacrylate and (iii) glycidyl acrylate or glycidyl methacrylate, and the molecules have terminal glycidyl groups.

The present invention relates to asphalt-epoxy resin compositions for pavement purposes which have excellent flow-resistance when the temperature is high, and which have excellent low temperature cracking resistance and aggregate-scattering resistance.

Asphalt is used in a wide range of applications such as road pavements and waterproofing.

In general, the asphalt which is used as a road pavement softens under hot summer weather conditions and flows easily, and it becomes hard under winter weather conditions and its elasticity is reduced.

Furthermore, in recent years the amount of traffic on trunk roads has increased and the load on the pavement itself due to traffic has increased.

Hence, improvements in respect of the resistance to flow at high temperatures, the cracking resistance at low temperatures and the resistance to the scattering of aggregate are desirable.

Furthermore, the asphalt compositions which are used for water-draining pavements which have the function of ensuring driving safety in the rain and reducing traffic noise have a large void factor and so greater flow resistance, cracking resistance and aggregate scattering resistance are also required.

The use of water-draining pavements has increased year on year centring on high specification trunk road pavements. Modified asphalts wherein additives such as thermoplastic elastomers and petroleum resins are compounded in the asphalt have been suggested as materials for use in pavements which have higher durability and a better water-draining function. However, there are problems with pavement damage due to wheel-rut formation and the tyre-twisting actions which are produced by traffic loading and hot weather conditions and with a reduction in the performance of water-draining pavement caused by-low temperature cracking which arises under cold weather conditions and aggregate scattering due to the use of tyre chains for example.

Methods in which asphalt and epoxy resins are used conjointly have been proposed for resolving the abovementioned problems.

For example, in Japanese Unexamined Patent Application Laid Open H2-302425 there is disclosed an asphalt-epoxy resin composition for pavement purposes which contains poly-epoxy compound, modified polyamine compound and asphalt.

In Japanese Unexamined Patent Application Laid Open H7-268221 there is described an asphalt-epoxy resin composition comprising petroleum asphalt, epoxy resin which is liquid at normal temperature and olefin-maleic acid anhydride adduct, and it is disclosed that this is an asphalt-epoxy resin composition which has excellent durability and aggregate-holding power.

In Japanese Unexamined Patent Application Laid Open H9-124900 there is disclosed an asphalt composition for pavement purposes in which epoxy resin and hardener are compounded in straight asphalt or an asphalt which contains rubber-thermoplastic elastomer, and the hardener is a saturated or unsaturated aliphatic monoamine which has from 14 to 20 carbon atoms, and it is disclosed that this composition can provide water-draining pavement where the pavement itself has a high void factor, and that it has excellent performance in terms of laying and durability in that, for example, the strength of the pavement itself after laying the road is high and there is little wheel-rut formation

In Japanese Unexamined Patent Application Laid Open H10-182982 there is disclosed an asphalt-epoxy resin composition which contains asphalt, epoxy resin, epoxy-hardener and maleinated thermoplastic elastomer and/or thermoplastic resin, and it is disclosed that this is an asphalt-epoxy resin composition which has excellent flow resistance, wear resistance, load resistance, laying properties and low temperature cracking resistance.

Furthermore, in Japanese Unexamined Patent Application Laid Open 2003-64156 there is disclosed an asphalt-epoxy resin composition for pavement purposes comprising asphalt, epoxy resin and hardener in which said epoxy resin is a rubber-containing liquid epoxy resin and said hardener comprises aliphatic primary amine and poly-functional phenol resin, and it is disclosed that it has excellent flow resistance, wear resistance and laying properties.

However, the strength characteristics are poor immediately after the pavement has been established when the reaction between the epoxy resin and the epoxy hardener has not proceeded sufficiently and there is a problem with the formation of wheel ruts.

Furthermore, the asphalt-epoxy resin compositions can provide mixtures which have excellent durability at high temperature when compared with the high viscosity modified asphalts to which thermoplastic modifying materials have been added, but there is a problem in that they lack elasticity at low temperature.

Thus, it is highly desirable to develop asphalts for pavement purposes and in particular asphalt-epoxy resin compositions with which there is an improvement in respect of wheel-rut formation resistance as a result of the strength characteristics immediately after the pavement has been established being improved, and of which the flow resistance at high temperature, the cracking resistance at low temperature and the aggregate scattering resistance of the asphalt mixture are improved.

In one embodiment of the present invention, there is provided an asphalt-epoxy resin composition which contains in the indicated proportions (A) from 75 to 93 wt % asphalt, (B) from 1 to 5 wt % epoxy resin and (C) from 6 to 20 wt % maleic acid modified thermoplastic polymer wherein the total amount of (A)+(B)+(C) is 100 wt % and wherein the aforementioned epoxy resin (B) is a ternary copolymer comprising (i) lower α-olefin, (ii) lower alkyl acrylate or methacrylate and (iii) glycidyl acrylate or glycidyl methacrylate, and the molecules have terminal glycidyl groups.

In a further embodiment of the present invention, the epoxy resin (B) in the asphalt-epoxy resin composition, is a ternary copolymer comprising (i) ethylene, (ii) n-butyl acrylate or methacrylate and (iii) glycidyl acrylate or glycidyl methacrylate, and the molecules have terminal glycidyl groups.

In another embodiment of the present invention, the epoxy resin (B) in the asphalt-epoxy resin composition is a ternary copolymer comprising (i) from 30 to 90 wt % ethylene, (ii) from 10 to 70 wt % n-butyl acrylate or methacrylate and (iii) from 0.5 to 30 wt % glycidyl acrylate or glycidyl methacrylate wherein the total amount of (i)+(ii)+(iii) is 100 wt %, and the molecules have terminal glycidyl groups.

In a still further embodiment of the present invention, the maleic acid modified thermoplastic polymer (C) in the asphalt-epoxy resin composition comprises (iv) a polymer of melting point from 80 to 105° C. where an ethylene-ethyl acrylate copolymer has been modified with maleic acid and the proportion of said polymer with respect to the asphalt-epoxy resin composition is from 0.1 to 18 wt %, and (v) a maleic acid modified styrene-ethylene-butylene-styrene block copolymer (SEBS) and the proportion of said polymer with respect to the asphalt-epoxy resin composition is from 2 to 6 wt %, and wherein the total amount of (iv)+(v) is from 6 to 20 wt %.

As hereinbefore described, whilst conventional asphalt-epoxy resin compositions can provide mixtures which have excellent flow-resistance at high temperatures when compared with the high viscosity modified asphalts to which thermoplastic modifying materials have been added, problems with the aggregate scattering resistance and cracking resistance at low temperatures have been indicated.

In the present invention, it has surprisingly been discovered that the flow resistance at high temperature, the cracking resistance at low temperature and the aggregate scattering resistance can be improved by causing the epoxy groups of an epoxy resin which has excellent flexibility at low temperature to react with the carboxyl groups of a thermoplastic elastomer which has been maleic acid modified, thereby improving the aggregate scattering resistance and the cracking resistance at low temperature.

Furthermore, whilst the conventional asphalt-epoxy resin compositions can provide pavements which have excellent strength characteristics when the reaction between the epoxy resin and the epoxy hardener has been more or less completed (when it is completely hardened), the strength characteristics are poor immediately after the pavement has been established in the initial stages of the reaction between the epoxy resin and the epoxy hardener and the formation of wheel ruts has been indicated as a problem area.

In the present invention, it will be appreciated that “pavement” encompasses road pavements for vehicles.

The maleic acid modified thermoplastic polymers (C) used in the present invention have a high melting point and an elastic nature and they also have excellent reactivity with epoxy resins and so it is possible to improve the flow resistance (the wheel-rut formation resistance) immediately after the pavement has been established in the initial stages of the reaction between the epoxy resin and the epoxy hardener.

The epoxy resins (B) used in the compositions of the present invention are ternary copolymers comprising (i) lower a-olefin, (ii) lower alkyl acrylate or methacrylate and (iii) glycidyl acrylate or glycidyl methacrylate, and the molecules have terminal glycidyl groups. The lower a-olefin (i) is preferably ethylene, propylene or butylene and ethylene is especially desirable since it provides excellent impact resistance at low temperature. The lower alkyl group of the lower alkyl acrylate or methacrylate (ii) is preferably a methyl, ethyl, propyl or butyl group, and the butyl group is particularly preferred since it is able to impart flexibility in particular to the structure of the asphalt product.

The epoxy resin (B) used in the compositions of the present invention is preferably a ternary copolymer comprising (i) from 30 to 90 wt % ethylene, (ii) from 10 to 70 wt % n-butyl acrylate or methacrylate, and (iii) from 0.5 to 30 wt % glycidyl acrylate or glycidyl methacrylate, wherein the total amount of (i)+(ii)+(iii) is 100 wt %, and the molecules have terminal glycidyl groups.

If the ethylene content is less than 30 wt % then the impact resistance at low temperatures may be reduced, and if it exceeds 90 wt % then mixing with the asphalt may become difficult. If the n-butyl acrylate or methacrylate content is less than 10 wt % then the water resistance of the asphalt structure may be reduced, and if it exceeds 70 wt % then the impact resistance may be reduced. Furthermore, reaction is less likely if the glycidyl acrylate or glycidyl methacrylate content is less than 0.5 wt % and the strength of the asphalt structure may be reduced, and if it exceeds 30 wt % then the rise in viscosity due to reaction is accelerated and it may not be possible to ensure an adequate usable time after producing the combined material before laying the pavement.

The proportion in which the epoxy resin (B) is compounded in the asphalt-epoxy resin composition of the present invention is preferably in the range of 1 to 5 wt %, based on the total weight of the composition. If the amount of epoxy resin (B) compounded therein exceeds 5 wt % then the rise in viscosity due to reaction is accelerated, the usable time after producing the combined material before laying the pavement cannot be ensured and the on-site operability may be poor.

Conversely, if the proportion of epoxy resin compounded is less than 1 wt % then reaction is less likely to occur and the strength characteristics of the asphalt-epoxy resin composition may be reduced.

The preferred properties of the epoxy resin include an MFR (melt flow rate) as indicated in JIS K 7210 of from 8 to 15 g/10 minutes (200° C., 49 N), and a glass transition point indicated using the dynamic viscoelasticity method of not more than −45° C.

If the MFR is less than 8 g/10 minutes then the on-site operability is poor, and conversely if it exceeds 15 g/10 minutes then the strength performance is reduced. If the glass transition point by the dynamic viscoelasticity method is above −45° C. then the bending strain in a bending test as disclosed on page 526 of the Pavement Test Methods Handbook (Nippon Dorokyokai, 1988) as a measure of low temperature cracking resistance is reduced and the cracking resistance is poor.

In the present invention, the proportion in which the maleic acid modified thermoplastic polymer (C) is compounded is such that from 6 to 20 wt % is included in the asphalt-epoxy resin composition of the present invention.

If the amount of maleic acid modified thermoplastic polymer (C) compounded may be less than 6 wt % then the hardening reaction is insufficient and the strength performance of the asphalt-epoxy resin composition may be inadequate. Furthermore, if the amount of maleic acid modified thermoplastic polymer (C) exceeds 20 wt % then the viscosity of the asphalt-epoxy resin composition itself rises, and the operability may become poor, the rise in viscosity due to reaction of the epoxy groups is accelerated and the usable time before laying cannot be adequately ensured.

Maleinated polyolefins, such as maleinated polyethylene and maleinated polypropylene, maleinated ethylene-vinyl acetate copolymers, petroleum resins produced from maleic acid modified petroleum fractions, maleic acid modified ethylene-ethyl acrylate copolymers, and maleic acid styrene-ethylene-butylene-styrene block copolymers (SEBS), for example, can be cited as maleic acid modified thermoplastic polymers of this invention.

These maleic acid modified thermoplastic polymers (C) are effective as the hardening agents for the epoxy compounds of the present invention. However, in some instances, maleinated polyethylene, maleinated polypropylene, maleinated ethylene-vinyl acetate copolymer and the petroleum resins produced from maleic acid modified petroleum fractions may not have desirable thermal stability at high temperature, and the petroleum resins produced from maleic acid modified petroleum fractions may also be low in terms of impact resistance at low temperatures. Moreover, the mixing properties of maleinated polyethylene with asphalt may also be difficult.

The maleic acid modified thermoplastic polymers (C) of the present invention are most desirably such that the maleic acid modified thermoplastic polymer comprises (iv) a polymer of melting point from 80 to 105° C. where an ethylene-ethyl acrylate copolymer has been modified with maleic acid and the proportion of said polymer with respect to the asphalt-epoxy resin composition is from 0.1 to 18 wt %, and (v) a maleic acid modified styrene-ethylene-butylene-styrene block copolymer (SEBS) and the proportion of said polymer with respect to the asphalt-epoxy resin composition is from 2 to 6 wt %, and wherein the total amount of (iv)+(v) is from 6 to 20 wt %.

If the melting point of the maleic acid modified ethylene-ethyl acrylate copolymer (iv) in this maleic acid modified thermoplastic polymer is less than 80° C. then void collapse and wheel rutting may be liable to occur. Conversely, if the melting point exceeds 105° C. then separation may occur on storing the asphalt composition which contains asphalt and the maleic acid modified ethylene-ethyl acrylate copolymer and, not only may it be difficult to ensure the strength of the pavement itself, but transportation and on-site operability may also become difficult. If there is less than 0.1 wt % of maleic acid modified ethylene-ethyl acrylate copolymer then the strength performance of the asphalt-epoxy resin composition may decline. Conversely, if it exceeds 18 wt % then the viscosity is increased and this may make the on-site operability poor.

Moreover, when a maleic acid modified styrene-ethylene-butylene-styrene block copolymer (SEBS) is included in the maleic acid modified thermoplastic polymer, the proportion of maleic acid modified SEBS in the asphalt-epoxy resin composition is most desirably from 2 to 6 wt %. If the maleic acid modified SEBS content exceeds 6 wt % then the rise in viscosity due to reaction may be accelerated, the usable time from producing the combined material to on-site laying cannot be ensured and the on-site operability may become poor. Conversely, if it is less than 2 wt % then reaction may become difficult and there may be a decline in the strength performance of the asphalt-epoxy resin composition. In terms of the properties of the maleic acid modified SEBS, the MFR indicated in JIS K 7210 is preferably from 3 to 6 g/10 minutes, and the acid value is preferably from 5 to 15 mg CH₃ONa/g. Moreover, the styrene in the styrene/ethylene-butylene ratio is preferably from 25 to 35 wt %. If the MFR is less than 3 g/10 minutes then the on-site operability may become poor as a result of the rise in viscosity, and if it exceeds 6 g/10 minutes then there may be a decline in the strength performance of the asphalt-epoxy resin mixture. If the acid value of the maleic acid modified SEBS is less than 5 mg CH₃ONa/g then the reactivity may be low and the final strength of the epoxy resin mixture may be reduced. Conversely, if it exceeds 15 mg CH₃ONa/g then the reactivity may be high, the rise in viscosity is accelerated and it may become difficult to ensure the usable time, and the on-site operability may become poor.

No particular limitation is imposed upon the asphalt (A) used in the present invention provided that it is an asphalt which can be used for pavement purposes. The asphalts indicated in Table 1 of JIS K 2207 and the semi-blown asphalts of Table 3.3.4 on page 51 of the Japanese Road Association Inc. revised publication “Outline of Asphalt Pavements” dated 13 Jan. 1997 may be conveniently used. Furthermore, the de-gravelled asphalts indicated under the propane de-gravelling method on page 308 and the extracts shown under the furfural method on page 304 of the Petroleum Society publication “New Petroleum Dictionary” (1982) may also be conveniently used.

The asphalt (A) is present in the asphalt-epoxy resin composition of the present invention in an amount in the range of from 75 to 93 wt %, based on the total amount of asphalt (A), epoxy resin (B) and maleic acid modified thermoplastic polymer (C).

In one embodiment of the present invention, the asphalt (A) used may conveniently include oil-extended asphalt. For example, asphalt extended with petroleum-based solvent extracted oil may be used. The amount of asphalt relative to oil in the oil-extended asphalt may be conveniently in the range of 20 to 90 wt %, with respect to the total amount of asphalt and oil.

The possibility of liquid leakage has arisen in those cases in the past where the epoxy resins which have been used have been liquids. However, the aforementioned epoxy resins used in the present invention are pellet-like solids at normal temperature and so they can be bagged up in the amounts required for making a combined material and introduced and admixed when producing the combined material. Consequently handling is easy at the production site and safety is also improved.

The present invention provides asphalt-epoxy resin compositions with which the wheel rutting resistance is improved by increasing the strength characteristics immediately after establishing the road pavement and with which the flow resistance at high temperature, the cracking resistance at low temperature and the aggregate scattering resistance of the asphalt mixture are improved.

The present invention further provides for the use of the asphalt-epoxy resin compositions as hereinbefore described for pavement applications.

The present invention is described below with reference to the following Examples, which are not intended to limit the scope of the present invention in any way.

### EXAMPLES

The properties of the individual components used in the Examples and Comparative Examples below were as follows:

Solvent De-Gravelled Asphalt

An asphalt of needle insertion 8, softening point 66. 5° C., density at 15° C. of 1028 kg/m³ and ignition point 352° C.

Petroleum Based Solvent Extracted Oil

A material of viscosity at 100° C. of 0.07 Pa.s, aromatic fraction 33 wt %, naphthene fraction 26 wt %, paraffin fraction 41% and ignition point 254° C.

Epoxy Resin (i)

An ethylene-acrylic acid ester-glycidyl acrylate-based ternary copolymer, of which the properties are density 940 kg/m³, melting point 74° C., glass transition point −55° C., tensile strength 5 MPa, elongation at breaking point 90% (JIS K 6723) and hardness (Shore A) 73.

Epoxy Resin (ii)

A bisphenol A type epoxy resin, of which the properties are viscosity (25° C.) 13.5 Pa.s, epoxy equivalent 200, specific gravity (25° C.) 1.17 and molecular weight 380.

Thermoplastic Polymers

(i) An ethylene-ethyl acrylate-maleic anhydride copolymer, of which the properties are density 930 kg/m³, melting point 100° C., tensile failure strength 686 N/cm², elongation at break 500% (JIS K 6730), flex rigidity 490 N/cm² (ASTM D 747).

(ii) A maleic acid modified styrene-ethylene-butylene-styrene block copolymer (SEBS), of which the properties are specific gravity 0.92, hardness (Shore A) 84 (JIS K 6253), 300% tensile stress 4.4 MPa, tensile strength 22 MPa, elongation 600% (JIS K 6251) and acid equivalent 10 mg CH₃ONa/g.

Method of Mixing and Sample Production

(1) The maleinated thermoplastic polymer or thermoplastic polymer was added to an oil-extended asphalt containing solvent de-gravelled asphalt and petroleum-based solvent extracted oil which were being maintained at a temperature of 180° C. and mixed for 2 hours at a mixing temperature of 180° C. and at a mixing stirrer rate of 3000 rpm using a homomixer. This mixed liquid was taken as liquid A.

(2) Liquid A which was being maintained at 170° C. and epoxy resin were mixed for 5 minutes at a mixing temperature of 170° C. at a mixing stirrer rate of 3000 rpm using a homomixer to prepare an asphalt-epoxy resin composition.

This asphalt-epoxy resin composition was then mixed immediately with the aggregate shown in Table 1 which was being maintained at 175° C. to prepare in accordance with the asphalt mixture formulation shown in Table 1.

(3) After mixing, the asphalt mixture was introduced into a Marshall stability test sample moulding frame and a wheel tracking test sample moulding frame as described on pages 506 and 539 of the “Pavement Test Methods Manual”, published by the Nippon Doro Kyokai (Co.) (1988), and the sample frames were each introduced into an oven which was being maintained at a temperature of 170° C. and matured for 90 minutes. After being matured for 90 minutes the samples were both removed from the oven and the Marshall stability sample was adjusted to a sample temperature of 155° C. and tamped fifty times using a Marshall hammer.

The wheel tracking sample was adjusted to a sample temperature of 155° C. and rolled. Samples were then used as initial strength samples. The initial strength samples were then removed from the Marshall sample moulding frame and the wheel tracking sample moulding frame and matured for 24 hours in an oven at 160° C. to provide final strength samples.

The wheel tracking test described on page 539 of the “Pavement Test Methods Manual”, published by the Nippon Doro Kyokai (Co.) (1988) was then carried out as a method for evaluating the flow resistance of the initial strength sample of each of the asphalt-epoxy resin compositions shown in Tables 1 and 2 for Examples 1 to 6 and Comparative Examples 1 to 9. Furthermore, the bending strain measurements of the bending test described on page 562 of the “Pavement Test Methods Manual”, published by the Nippon Doro Kyokai (Co.) (1988), as a means of evaluating the low temperature cracking resistance, and Cantabro tests as described on page 7 of the “Pavement Test Methods Manual Supplement” published by the Nippon Doro Kyokai (Co.) (1997) as a means of evaluating the aggregate scattering resistance were carried out with the final strength samples of each asphalt-epoxy resin composition. The test temperature in the Cantabro test was 0° C. Moreover, a separation test as described on page 29 of “Reports Concerning the Viscosity of Asphalt (Report 5) Eight-time Verification Test (published by the Sekiyu Gakkai, 1998) was carried out in terms of the storage stability as an evaluation of the storage stability when tank storage is being carried out. Moreover, when a sudden rise in viscosity occurs as a result of the reaction of the asphalt-epoxy resin composition after producing the combined material and before laying on site, the operability becomes poor and so the reaction times and viscosities were measured.

The optimum viscosity range for an asphalt-epoxy resin composition is preferably set to from 2 to 3 Pa.s in consideration of operability. If it is less than 2 Pa.s then dropping of the asphalt (the asphalt in the upper part flows into the lower part) occurs and a uniform mixture cannot be obtained, and if it exceeds 3 Pa.s then the mixture becomes too hard when establishing the pavement and it is difficult to form a smooth pavement surface. Hence, it was adjudged that the operability on site is good if the viscosity after 120 minutes is less than 3 Pa.s. Consequently, the time from first mixing until the viscosity reaches 3 Pa.s was taken to be usable time. The measurements were made using a Brookfield Co. rotary viscometer (Spindle No. SC4-27, measurement speed 20 rpm, measurement temperature 170° C.). The measured results are shown in Tables 1 and 2.

TABLE 1

| | | Amounts of Aggregate | |
|---|---|---|---|
| | | and Asphalt-Epoxy | |
| | | Resin Compounded | |
| Aggregate | No. 6 Crushed Stone | 82 | wt % |
| | Coarse Sand | 13 | wt % |
| | Stone Dust | 5 | wt % |

| | |
|---|---|
| Asphalt-Epoxy Resin Composition | 5 wt % (vs aggregate) |

TABLE 2

| Composition | | Example 1 | Example 2 | Example 3 |
|---|---|---|---|---|
| Liquid | Solvent de- | 26.0 | 55.0 | 51.0 |
| A | gravelled asphalt | | | |
| | (wt %) | | | |
| | Petroleum-based | 51.0 | 32.0 | 34.0 |
| | solvent extracted | | | |
| | oil (wt %) | | | |
| | Thermoplastic | 18.0 | 8.0 | 8.0 |
| | polymer (i) (wt %) | | | |
| | Thermoplastic | 2.0 | 4.0 | 4.0 |
| | polymer (ii) (wt %) | | | |

| | | | |
|---|---|---|---|
| Epoxy resin (i) (wt %) | 3.0 | 1.0 | 3.0 |
| Epoxy resin (ii) (wt %) | — | | |
| Dynamic stability*¹ | 21,000 | 7,000 | 9,000 |
| (times/mm) | | | |
| Bending strain*² (×10⁻³) | 4.15 | 4.50 | 5.25 |
| Cantabro loss factor*² (%) | 12.0 | 18.0 | 12.5 |
| Storage stability | No | No | No |
| (separation or no | separation | separation | separation |
| separation) | | | |
| Usable time (minutes) | ◯ | ◯ | ◯ |

*¹indicates with the initial strength sample,
*²indicates with the final strength sample
Usable Time
◯: More than 120 minutes,
X: Less than 120 minutes

TABLE 3

| Composition | | Example 4 | Example 5 | Example 6 |
|---|---|---|---|---|
| Liquid | Solvent de- | 47.0 | 64.0 | 36.0 |
| A | gravelled asphalt | | | |
| | (wt %) | | | |
| | Petroleum-based | 36.0 | 27.0 | 45.0 |
| | solvent extracted | | | |
| | oil (wt %) | | | |
| | Thermoplastic | 8.0 | 4.0 | 10.0 |
| | polymer (i) (wt %) | | | |
| | Thermoplastic | 4.0 | 2.0 | 6.0 |
| | polymer (ii) (wt %) | | | |

| | | | |
|---|---|---|---|
| Epoxy resin (i) (wt %) | 5.0 | 3.0 | 3.0 |
| Epoxy resin (ii) (wt %) | — | — | — |
| Dynamic stability*¹ | 10,500 | 5,725 | 21,000 |
| (times/mm) | | | |
| Bending strain*² (×10⁻³) | 6.00 | 4.50 | 5.25 |
| Cantabro loss factor*² (%) | 10.2 | 21.0 | 12.0 |
| Storage stability | No | No | No |
| (separation or no | separation | separation | separation |
| separation) | | | |
| Usable time (minutes) | ◯ | ◯ | ◯ |

*¹indicates with the initial strength sample,
*²indicates with the final strength sample
Usable Time
◯: More than 120 minutes,
X: Less than 120 minutes

TABLE 4

| Composition | | Comp. Ex. 1 | Comp. Ex. 2 | Comp. Ex. 3 |
|---|---|---|---|---|
| Liquid | Solvent de- | 57.0 | 47.0 | 76.0 |
| A | gravelled asphalt | | | |
| | (wt %) | | | |
| | Petroleum-based | 31.0 | 36.0 | 21.0 |
| | solvent extracted | | | |
| | oil (wt %) | | | |
| | Thermoplastic | 8.0 | 8.0 | — |
| | polymer (i) (wt %) | | | |
| | Thermoplastic | 4.0 | 4.0 | — |
| | polymer (ii) (wt %) | | | |

| | | | |
|---|---|---|---|
| Epoxy resin (i) (wt %) | — | — | 3.0 |
| Epoxy resin (ii) (wt %) | — | 5.0 | — |
| Dynamic stability*¹ | 6,300 | 9,000 | 1,050 |
| (times/mm) | | | |
| Bending strain*² (×10⁻³) | 3.75 | 3.00 | 2.15 |
| Cantabro loss factor*² (%) | 25.6 | 36.2 | 37.3 |
| Storage stability | No | No | No |
| (separation or no | separation | separation | separation |
| separation) | | | |
| Usable time (minutes) | ◯ | ◯ | ◯ |

*¹indicates with the initial strength sample,
*²indicates with the final strength sample
Usable Time
◯: More than 120 minutes,
X: Less than 120 minutes

TABLE 5

| Composition | | Comp. Ex. 4 | Comp. Ex. 5 | Comp. Ex. 6 |
|---|---|---|---|---|
| Liquid | Solvent de- | 32.7 | 46.0 | 68.8 |
| A | gravelled asphalt | | | |
| | (wt %) | | | |
| | Petroleum-based | 43.3 | 35.0 | 21.2 |
| | solvent extracted | | | |
| | oil (wt %) | | | |
| | Thermoplastic | 9.0 | 9.0 | |
| | polymer (i) (wt %) | | | |
| | Thermoplastic | 12.0 | 4.0 | 5.0 |
| | polymer (ii) (wt %) | | | |

| | | | |
|---|---|---|---|
| Epoxy resin (i) (wt %) | 3.0 | 6.0 | 5.0 |
| Epoxy resin (ii) (wt %) | — | — | — |
| Dynamic stability*¹ | 31,500 | 15,750 | 5,250 |
| (times/mm) | | | |
| Bending strain*² (×10⁻³) | 2.85 | 6.25 | 2.15 |
| Cantabro loss factor*² (%) | 37.0 | 12.0 | 29.3 |
| Storage stability | No | No | No |
| (separation or no | separation | separation | separation |
| separation) | | | |
| Usable time (minutes) | X | X | ◯ |

*¹indicates with the initial strength sample,
*²indicates with the final strength sample
Usable Time
◯: More than 120 minutes,
X: Less than 120 minutes

TABLE 6

| | | Comp. Ex. | Comp. Ex. | Comp. Ex. |
|---|---|---|---|---|
| Composition | | 7 | 8 | 9 |
| Liquid | Solvent de- | 25.0 | 29.6 | 18.0 |
| A | gravelled asphalt | | | |
| | (wt %) | | | |
| | Petroleum-based | 50.0 | 46.4 | 63.0 |
| | solvent extracted | | | |
| | oil (wt %) | | | |
| | Thermoplastic | 21.0 | 20.2 | 8.0 |
| | polymer (i) (wt %) | | | |
| | Thermoplastic | 3.0 | 1.0 | 3.0 |
| | polymer (ii) (wt %) | | | |

| | | | |
|---|---|---|---|
| Epoxy resin (i) (wt %) | 1.0 | 3.0 | 8.0 |
| Epoxy resin (ii) (wt %) | — | — | — |
| Dynamic stability*¹ | 9,000 | 21,000 | 15,750 |
| (times/mm) | | | |
| Bending strain*² (×10⁻³) | 5.25 | 4.05 | 1.95 |
| Cantabro loss factor*² (%) | 26.3 | 19.5 | 31.5 |
| Storage stability | Separation | Separation | No |
| (separation or no | | | Separation |
| separation) | | | |
| Usable time (minutes) | ◯ | X | X |

*¹indicates with the initial strength sample,
*²indicates with the final strength sample
Usable Time
◯: More than 120 minutes,
X: Less than 120 minutes

1. An asphalt-epoxy resin composition which contains in the indicated proportions (A) from 75 to 93 wt % asphalt, (B) from 1 to 5 wt % epoxy resin and (C) from 6 to 20 wt % maleic acid modified thermoplastic polymer wherein the total amount of (A)+(B)+(C) is 100 wt %, and wherein the aforementioned epoxy resin (B) is a ternary copolymer comprising (i) lower a-olefin, (ii) lower alkyl acrylate or methacrylate and (iii) glycidyl acrylate or glycidyl methacrylate, and the molecules have terminal glycidyl groups.

2. The asphalt-epoxy resin composition of claim 1, wherein the (i) lower α-olefin is ethylene, propylene or butylene.

3. The asphalt-epoxy resin composition of claim 1, wherein the lower alkyl group of the lower alkyl acrylate or methacrylate (ii) is a methyl, ethyl, propyl or butyl group.

4. The asphalt-epoxy resin composition of claim 1, wherein the epoxy resin (B) is a ternary copolymer comprising (i) ethylene, (ii) n-butyl acrylate or methacrylate and (iii) glycidyl acrylate or glycidyl methacrylate, and the molecules have terminal glycidyl groups.

5. The asphalt-epoxy resin composition of claim 1, wherein the epoxy resin (B) is a ternary copolymer comprising (i) from 30 to 90 wt % ethylene, (ii) from 10 to 70 wt % n-butyl acrylate or methacrylate and (iii) from 0.5 to 30 wt % glycidyl acrylate or glycidyl methacrylate, wherein the total amount of (i)+(ii)+(iii) is 100 wt %, and the molecules have terminal glycidyl groups.

6. The asphalt-epoxy resin composition of claim 1 wherein the maleic acid modified thermoplastic polymer (C) is selected from one or more compounds of maleinated polyolefins, such as maleinated polyethylene and maleinated polypropylene, maleinated ethylene-vinyl acetate copolymers, petroleum resins produced from maleic acid modified petroleum fractions, maleic acid modified ethylene-ethyl acrylate copolymers, and maleic acid styrene-ethylene-butylene-styrene block copolymers (SEBS).

7. The asphalt-epoxy resin composition claim 1, wherein the maleic acid modified thermoplastic polymer (C) comprises (iv) a polymer of melting point from 80 to 105° C. where an ethylene-ethyl acrylate copolymer has been modified with maleic acid and the proportion of said polymer with respect to the asphalt-epoxy resin composition is from 0.1 to 18 wt %, and (v) a maleic acid modified styrene-ethylene-butylene-styrene block copolymer (SEBS) and the proportion of said polymer with respect to the asphalt-epoxy resin composition is from 2 to 6 wt %, and wherein the total amount of (iv)+(v) is from 6 to 20 wt %.

8. The asphalt-epoxy resin composition of claim 1, wherein the asphalt is an oil-extended asphalt.

9. Use of the asphalt-epoxy resin composition of claim 1 for pavement applications.

10. The asphalt-epoxy resin composition of claim 2, wherein the lower alkyl group of the lower alkyl acrylate or methacrylate (ii) is a methyl, ethyl, propyl or butyl group.

11. The asphalt-epoxy resin composition of claim 2, wherein the epoxy resin (B) is a ternary copolymer comprising (i) ethylene, (ii) n-butyl acrylate or methacrylate and (iii) glycidyl acrylate or glycidyl methacrylate, and the molecules have terminal glycidyl groups.

12. The asphalt-epoxy resin composition of claim 3, wherein the epoxy resin (B) is a ternary copolymer comprising (i) ethylene, (ii) n-butyl acrylate or methacrylate and (iii) glycidyl acrylate or glycidyl methacrylate, and the molecules have terminal glycidyl groups.

13. The asphalt-epoxy resin composition of claim 2, wherein the epoxy resin (B) is a ternary copolymer comprising (i) from 30 to 90 wt % ethylene, (ii) from 10 to 70 wt % n-butyl acrylate or methacrylate and (iii) from 0.5 to 30 wt % glycidyl acrylate or glycidyl methacrylate, wherein the total amount of (i)+(ii)+(iii) is 100 wt %, and the molecules have terminal glycidyl groups.

14. The asphalt-epoxy resin composition of claim 3, wherein the epoxy resin (B) is a ternary copolymer comprising (i) from 30 to 90 wt % ethylene, (ii) from 10 to 70 wt % n-butyl acrylate or methacrylate and (iii) from 0.5 to 30 wt % glycidyl acrylate or glycidyl methacrylate, wherein the total amount of (i)+(ii)+(iii) is 100 wt %, and the molecules have terminal glycidyl groups.

15. The asphalt-epoxy resin composition of claim 4, wherein the epoxy resin (B) is a ternary copolymer comprising (i) from 30 to 90 wt % ethylene, (ii) from 10 to 70 wt % n-butyl acrylate or methacrylate and (iii) from 0.5 to 30 wt % glycidyl acrylate or glycidyl methacrylate, wherein the total amount of (i)+(ii)+(iii) is 100 wt %, and the molecules have terminal glycidyl groups.

16. The asphalt-epoxy resin composition of claim 2, wherein the maleic acid modified thermoplastic polymer (C) is selected from one or more compounds of maleinated polyolefins, such as maleinated polyethylene and maleinated polypropylene, maleinated ethylene-vinyl acetate copolymers, petroleum resins produced from maleic acid modified petroleum fractions, maleic acid modified ethylene-ethyl acrylate copolymers, and maleic acid styrene-ethylene-butylene-styrene block copolymers (SEBS).

17. The asphalt-epoxy resin composition of claim 3, wherein the maleic acid modified thermoplastic polymer (C) is selected from one or more compounds of maleinated polyolefins, such as maleinated polyethylene and maleinated polypropylene, maleinated ethylene-vinyl acetate copolymers, petroleum resins produced from maleic acid modified petroleum fractions, maleic acid modified ethylene-ethyl acrylate copolymers, and maleic acid styrene-ethylene-butylene-styrene block copolymers (SEBS).

18. The asphalt-epoxy resin composition of claim 4, wherein the maleic acid modified thermoplastic polymer (C) is selected from one or more compounds of maleinated polyolefins, such as maleinated polyethylene and maleinated polypropylene, maleinated ethylene-vinyl acetate copolymers, petroleum resins produced from maleic acid modified petroleum fractions, maleic acid modified ethylene-ethyl acrylate copolymers, and maleic acid styrene-ethylene-butylene-styrene block copolymers (SEBS).

19. The asphalt-epoxy resin composition of claim 5, wherein the maleic acid modified thermoplastic polymer (C) is selected from one or more compounds of maleinated polyolefins, such as maleinated polyethylene and maleinated polypropylene, maleinated ethylene-vinyl acetate copolymers, petroleum resins produced from maleic acid modified petroleum fractions, maleic acid modified ethylene-ethyl acrylate copolymers, and maleic acid styrene-ethylene-butylene-styrene block copolymers (SEBS).

20. The asphalt-epoxy resin composition of claim 2, wherein the maleic acid modified thermoplastic polymer (C) comprises (iv) a polymer of melting point from 80 to 105° C. where an ethylene-ethyl acrylate copolymer has been modified with maleic acid and the proportion of said polymer with respect to the asphalt-epoxy resin composition is from 0.1 to 18 wt %, and (v) a maleic acid modified styrene-ethylene-butylene-styrene block copolymer (SEBS) and the proportion of said polymer with respect to the asphalt-epoxy resin composition is from 2 to 6 wt %, and wherein the total amount of (iv)+(v) is from 6 to 20 wt %.
